(19) United States
(12) Patent Application Publication
(10) Pub. No.: US 2005/0124714 A1
(43) Pub. Date: Jun. 9, 2005

(54) Coating compositions

(75) Inventors: Jan Weikard, Odenthal (DE); Holger Mundstock, Wermelskirchen (DE); Jorg Schmitz, Koln (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/003,764

(22) Filed: Dec. 3, 2004

(30) Foreign Application Priority Data
Dec. 9, 2003 (DE) 10357713.0

(51) Int. Cl. C08G 2/00; C08F 2/46

(52) U.S. Cl. 522/35; 528/44

(57) ABSTRACT

Quick-drying, solvent-based coating compositions, which are curable by UV-A radiation and contain at least one amorphous polyurethane with a glass transition temperature of from 35° C. to 100° C., the proportion by weight of soft groups in said amorphous polyurethane being less than 30 wt. %. The compositions are prepared by mixing all of the components that are free of isocyanate groups, and mixing in the components that contain free isocyanate groups just before application to a substrate.

### CROSS REFERENCE TO RELATED PATENT APPLICATION

The present patent application claims the right of priority under 35 U.S.C. § 119 a)-(d) of German Patent Application No.103 57 713.0, filed Dec. 9, 2003.

### BACKGROUND OF THE INVENTION

1. Field of the Invention

The present invention relates to quick-drying, solvent-based coating compositions and to their preparation and use.

2. Description of the Prior Art

Quick-drying, solvent-based coating compositions can be cured with actinic radiation and are used especially in the repair lacquering of motor vehicles. Lacquers curable with actinic radiation are known as highly-productive coating compositions. One disadvantage of these lacquers, especially in the case of systems based on the photopolymerization of acrylates or methacrylates, is that they only cure in those surface regions of the coated object which have been irradiated with an adequate dose and intensity. For objects of more complicated shape, it is therefore preferable to use dual-cure coating compositions, which, in addition to photopolymerization, also rely on a curing mechanism independent of irradiation, for example a crosslinking reaction of polyisocyanates with polyols. However, said crosslinking reaction typically proceeds very slowly at room temperature (>24 h) or within about 30 min at temperatures of 130° C. For some applications, especially for the coating of temperature-sensitive objects or objects which cannot economically be heated to temperatures of approx. 130° C. because of their size and geometry, it is necessary to cure the lacquer within a short period of time without heating, and in some cases without irradiation, so that three-dimensional shapes and parts of the bodies to be coated which escape exposure because of their geometry can also be provided with a cured coating.

Particularly in the repair lacquering of motor vehicles, but also for other lacquering processes performed manually, there are considerable doubts as to whether, for reasons of cost and health and safety at work, the high-pressure and medium-pressure mercury vapour radiators typically used e.g. in the industrial lacquering of wood/furniture or for curing printing inks can also be used in the manual sector. The latter sector preferentially uses inexpensive mobile radiators with emissions mostly restricted to the so-called UV-A region of the electromagnetic spectrum, whose dose and intensity are substantially lower. There is therefore a need for coating compositions that exhibit rapid drying or curing on irradiation with UV-A light even in non-irradiated or inadequately irradiated regions. Furthermore, the proportion of volatile organic solvents in the fully-processed coating composition should be minimal in the spray application that is typically used.

WO 00/063 015 teaches the production of a laminated sheet capable of being deep drawn, which has a radiation-curable coating containing a binder with a glass transition temperature (Tg) above 40° C. The coating compositions used have very high viscosities and a spray application at room temperature is not described. The radiation curing is effected with high-energy UV radiation or electron radiation, usually at elevated temperature; curing exclusively with UV-A radiation is not described.

### SUMMARY OF THE INVENTION

The present invention is directed to coating compositions which are curable by UV-A radiation and contain at least one amorphous polyurethane with a glass transition temperature of from 35° C. to 100° C., the proportion by weight of soft groups in said amorphous polyurethane being less than 30 wt. %.

The present invention is also directed to a process for the preparation of the above-described coating compositions that includes mixing all of the components that are free of isocyanate groups, and mixing in the components that contain free isocyanate groups just before application to a substrate.

The present invention is additionally directed to a method of repairing lacquering by applying the above-described composition to a lacquered object.

The present invention is further directed to large objects lacquered with the above-described compositions as well as to substrates coated with at least one layer obtained from the above-described coating compositions.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

It has been found that solvent-based coating compositions which contain certain urethane acrylates and/or methacrylates, hereafter denoted as urethane (meth)acrylates, with a high glass transition temperature and a comparatively low solution viscosity exhibit a very good reactivity on irradiation with UV-A light and very rapid drying in non-irradiated regions.

The invention accordingly provides one-component or multicomponent solvent-based coating compositions which are curable by UV-A radiation and contain at least one amorphous polyurethane with a glass transition temperature of 35 to 100° C., the proportion by weight of soft groups in said amorphous polyurethane being less than 30 wt. %.

The invention also provides the preparation of the coating compositions and their use for the coating of various substrates, as well as substrates coated with the coating compositions according to the invention.

The coating compositions according to the invention can cure purely by radiation-induced free-radical polymerization or can additionally crosslink by radiation-independent mechanisms such as (poly)addition reactions or possibly also poly-condensation reactions. Curing under the influence of oxygen is another possibility. Preferred crosslinking mechanisms are those which proceed at low temperatures, especially below 60° C., within eight hours to a sufficient degree of completion that even the non-irradiated coating cures until dry to handle. Particular examples are the isocyanate-hydroxyl reaction and the reaction of isocyanate with aminic components. Depending on the presence and type of the additional crosslinking mechanism, it is advisable to prepare the coating composition in several separate components and only to combine these shortly before coating. Alternatively, it may be advisable to mask or block at least one chemical functionality used for crosslinking without irradiation. Examples are certain blocked polyisocyanates (e.g. WO 03/004 545) that react at low temperatures, especially below 60° C., or masked polyhydroxyl compounds such as certain orthoester or oxazolidine compounds like the cyclic orthoester compounds or urethane bisoxazolidines described in EP-A 0 882 106, e.g. OZ hardener (Bayer AG, Leverkusen, DE), which, under the influence of water, especially atmospheric moisture, release chemical groups capable of reacting with isocyanates.

The amorphous polyurethanes used according to the invention with a glass transition temperature of 35 to 100° C., preferably of 40 to 76° C. and particularly preferably of 40 to 52° C., are preferably linear, but can also be branched, and can carry no additional functional groups, but preferably do carry additional functional groups. Preferred functional groups are those which participate in the chemical curing mechanisms of the coating compositions according to the invention. These are particularly hydroxyl groups, isocyanate groups and/or groups polymerizable by actinic radiation, (meth)acrylate groups being a preferred example. Particularly preferred polyurethanes are those which have a minimal influence on the solids content of the coating composition adjusted to the processing viscosity with solvent. As an approximation, these are particularly polyurethanes which have a low melt viscosity. Particularly preferred polyurethanes are disclosed in U.S. Patent Application Publication 2003/0134125 as binders for UV-curing powder coatings. The definition of soft groups disclosed in said patent specification also applies correspondingly to the polyurethanes of the coating composition according to the invention. The relevant portions of U.S. Patent Application Publication 2003/0134125 are herein incorporated by reference.

Apart from the amorphous polyurethanes described, the coating compositions according to the invention can contain other components, at least one of components A2 to A4 and/or the amorphous polyurethane containing one or more functional groups that undergo a polymerization reaction with ethylenically unsaturated compounds under the action of actinic radiation:

A1) at least one photoinitiator,

A2) optionally at least one compound which has at least one isocyanate-reactive group and optionally contains one or more functional groups that undergo a polymerization reaction with ethylenically unsaturated compounds under the action of actinic radiation,

A3) optionally polyisocyanates which optionally contain one or more functional groups that undergo a polymerization reaction with ethylenically unsaturated compounds under the action of actinic radiation,

A4) optionally compounds which carry functional groups that undergo a polymerization reaction with ethylenically unsaturated compounds under the action of actinic radiation, and which have neither isocyanate groups nor isocyanate-reactive groups,

A5) optionally catalysts and

A6) optionally auxiliary substances and additives.

Photoinitiators Al are initiators activatable by actinic radiation which initiate free-radical polymerization of the appropriate polymerizable groups. Photoinitiators that are activated by UV-A and/or visible light are preferred here. Photoinitiators are commercially available compounds known per se which fall into two types: unimolecular (type I) and bimolecular (type II) initiators. Examples of type I systems are aromatic ketone compounds, e.g. benzophenones in combination with tertiary amines, alkylbenzophenones, 4,4′-bis(dimethylamino)benzophenone (Michler's ketone), anthrone and halogenated benzophenones, or mixtures of said types. Also suitable are type II initiators such as benzoin and its derivatives, benzil ketals, acylphosphine oxides, e.g. 2,4,6-trimethylbenzoyldiphenylphosphine oxide, bisacylphosphine oxides, phenylglyoxylic acid esters, camphorquinone, α-aminoalkylphenones, α,α-dialkoxyacetophenones and α-hydroxyalkylphenones. It may also be advantageous to use mixtures of these compounds. The type and concentration of photoinitiator must be adapted, in a manner known to those skilled in the art, according to the radiation source used for curing. A more detailed description can be found e.g. in P.K.T. Oldring (Ed.), Chemistry & Technology of UV & EB Formulations for Coatings, Inks & Paints, Vol. 3, 1991, SITA Technology, London, pp 61-328.

The compounds of component A2) can be monomeric, oligomeric or polymeric and they contain at least one and preferably two or more isocyanate-reactive groups such as hydroxyl, amino, aspartyl and/or thiol groups, hydroxyl groups being preferred.

Suitable compounds of component A2) are low-molecular aliphatic, araliphatic or cycloaliphatic diols, triols and/or higher polyols having short chains, i.e. containing 2 to 20 carbon atoms. Examples of diols are ethylene glycol, diethylene glycol, triethylene glycol, tetraethylene glycol, dipropylene glycol, tripropylene glycol, 1,2-propanediol, 1,3-propanediol, 1,4-butanediol, neopentyl glycol, 2-ethyl-2-butylpropanediol, trimethylpentanediol, positional isomers of diethyloctanediols, 1,3-butylene glycol, cyclohexanediol, 1,4-cyclohexane-dimethanol, 1,6-hexanediol, 1,2- and 1,4-cyclohexanediol, hydrogenated bisphenol A (2,2-bis(4-hydroxycyclohexyl)propane) and 2,2-dimethyl-3-hydroxypropyl 2,2-dimethyl-3-hydroxypropionate. Examples of suitable triols are trimethylolethane, trimethylolpropane and glycerol. Suitable alcohols of higher functionality are ditrimethylolpropane, pentaerythritol, dipentaerythritol and sorbitol.

Other suitable compounds are higher-molecular polyols such as polyesterpolyols, polyetherpolyols, hydroxy-functional acrylic resins, hydroxy-functional polyurethanes and corresponding hybrids (cf. Rompp Lexikon Chemie, pp 465 -466, 10th ed., 1998, Georg-Thieme-Verlag, Stuttgart).

Other compounds of component A2) which can be used are any compounds, individually or in arbitrary mixtures, which have at least one isocyanate-reactive group and at least one unsaturated functional group that undergoes a polymerization reaction with ethylenically unsaturated compounds under the action of actinic radiation.

It is preferable to use α,β-unsaturated carboxylic acid derivatives such as acrylates, methacrylates, maleates, fumarates, maleimides and acrylamides, as well as vinyl ethers, propenyl ethers, allyl ethers and compounds containing dicyclopentadienyl units, which have at least one isocyanate-reactive group, particular preference being given to acrylates and methacrylates having at least one isocyanate-reactive group.

Examples of suitable hydroxy-functional acrylates or methacrylates are compounds such as 2-hydroxyethyl (meth)acrylate, polyethylene oxide mono(meth)acrylates, polypropylene oxide mono(meth)acrylates, polyalkylene oxide mono(meth)acrylates, poly(ε-caprolactone) mon6(meth)acrylates, e.g. Tone® M100 (Dow, Schwalbach, DE), 2-hydroxypropyl (meth)acrylate, 4-hydroxybutyl (meth)acrylate, 3-hydroxy-2,2-dimethylpropyl (meth)acrylate, the hydroxy-functional mono-, di- or tetraacrylates of polyhydric alcohols such as trimethylolpropane, glycerol, pentaerythritol or dipentaerythritol, ethoxylated, propoxylated or alkoxylated trimethylolpropane, glycerol, pentaerythritol or dipentaerythritol, or technical-grade mixtures thereof.

Other suitable compounds are isocyanate-reactive oligomeric or polymeric compounds containing unsaturated acrylate and/or methacrylate groups, either on their own or in combination with the above-mentioned monomeric compounds. Preference is given here to polyester acrylates containing hydroxyl groups and having an OH content of 30 to 300, preferably of 60 to 200 and particularly preferably of 70 to 120 mg KOH/g.

The preparation of polyester acrylates is described in DE-A 4 040 290 (p. 3, 1.25-p. 6, 1.24), DE-A 3 316 592 (p. 5, 1.14- p. 11, 1.30) and P.K.T. Oldring (Ed.), Chemistry & Technology of UV & EB Formulations for Coatings, Inks & Paints, Vol. 2, 1991, SITA Technology, London, pp 123 - 135.

The following compounds known per se can also be used: epoxy(meth)acrylates containing hydroxyl groups and having OH contents of 20 to 300 mg KOH/g, preferably of 100 to 280 mg KOH/g and particularly preferably of 150 to 250 mg KOH/g, or polyurethane (meth)acrylates containing hydroxyl groups and having OH contents of 20 to 300 mg KOH/g, preferably of 40 to 150 mg KOH/g and particularly preferably of 50 to 100 mg KOH/g, or acrylated polyacrylates having OH contents of 20 to 300 mg KOH/g, preferably of 40 to 150 mg KOH/g and particularly preferably of 50 to 100 mg KOH/g, as well as mixtures thereof with one another and mixtures with unsaturated polyesters containing hydroxyl groups, and mixtures with polyester (meth)acrylates or mixtures of unsaturated polyesters containing hydroxyl groups with polyester (meth)acrylates. Such compounds are also described in P.K.T. Oldring (Ed.), Chemistry & Technology of UV & EB Formulations for Coatings, Inks & Paints, Vol. 2, 1991, SITA Technology, London, pp 37-56. Epoxy(meth)acrylates containing hydroxyl groups are based especially on reaction products of acrylic acid and/or methacrylic acid with epoxides (glycidyl compounds) of monomeric, oligomeric or polymeric bisphenol A, bisphenol F, hexanediol and/or butanediol or their ethoxylated and/or propoxylated derivatives. Acrylated polyacrylates can be prepared for example by reacting glycidyl-functional polyacrylates with (meth)acrylic acid.

Polyisocyanates A3) are aromatic, araliphatic, aliphatic or cycloaliphatic diisocyanates or polyisocyanates. Mixtures of such diisocyanates or polyisocyanates can also be used. Examples of suitable diisocyanates or polyisocyanates are butylene diisocyanate, hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or mixtures thereof with arbitrary isomer contents, isocyanatomethyl-1,8-octane diisocyanate, 1,4-cyclohexylene diisocyanate, the isomeric cyclohexanedimethylene diisocyanates, 1,4-phenylene diisocyanate, 2,4- and/or 2,6-toluylene diisocyanate, 1,5-naphthylene diisocyanate, 2,4′- or 4,4′-diphenylmethane diisocyanate, triphenylmethane 4,4′,4″-triisocyanate or derivatives thereof with a urethane, urea, carbodiimide, acylurea, isocyanurate, allophanate, biuret, oxadiazinetrione, uretdione or iminooxadiazinedione structure, and mixtures thereof. Preference is given to polyisocyanates based on oligomerized and/or derivatized diisocyanates from which excess diisocyanate has been removed as far as possible by suitable processes, especially those based on hexamethylene diisocyanate, isophorone diisocyanate and the isomeric bis(4,4′-isocyanatocyclohexyl)methanes, and mixtures thereof. The oligomeric isocyanurates and iminooxadiazinediones of HDI and mixtures thereof, and the oligomeric isocyanurates of IPDI, are particularly preferred.

The polyisocyanates A3) can optionally contain one or more functional groups that undergo a polymerization reaction with ethylenically unsaturated compounds under the action of actinic radiation. These groups can be prepared by reacting the unsaturated isocyanate-reactive compounds mentioned under A2) with saturated polyisocyanates by methods known per se, e.g. urethanization and/or allophanation, preference being given to the monomeric unsaturated isocyanate-reactive compounds mentioned under A2).

Compounds of component A4) which can be used are modified monomers or polymers that undergo a polymerization reaction with ethylenically unsaturated compounds under the action of actinic radiation. The modification is effected by methods known per se and consists in introducing appropriate chemical functionalities into the molecules. Suitable compounds are α,β-unsaturated carboxylic acid derivatives such as acrylates, methacrylates, maleates, fumarates, maleimides and acrylamides, as well as vinyl ethers, propenyl ethers, allyl ethers and compounds containing dicyclopentadienyl units. Acrylates and methacrylates are preferred. Examples include the reactive thinners known in radiation curing technology (cf. Römpp Lexikon Chemie, p. 491, 10th ed., 1998, Georg-Thieme-Verlag, Stuttgart) or the binders known in radiation curing technology, such as polyether acrylates, polyester acrylates, urethane acrylates, epoxyacrylates, melamine acrylates, silicone acrylates, polycarbonate acrylates and acrylated polyacrylates, provided they have a hydroxyl group content below 30, preferably below 20 and particularly preferably below 10 mg KOH/g.

The acrylic acid or methacrylic acid esters, preferably the acrylic acid esters, of the following alcohols may be mentioned as examples of constituents of A4). Mono-hydric alcohols are the isomeric butanols, pentanols, hexanols, heptanols, octanols, nonanols and decanols, and also cycloaliphatic alcohols such as isoborneol, cyclohexanol and alkylated cyclohexanols, and dicyclopentanol, arylaliphatic alcohols such as phenoxyethanol and nonylphenylethanol, and tetrahydrofurfuryl alcohols. It is also possible to use alkoxylated derivatives of these alcohols. Examples of dihydric alcohols are alcohols such as ethylene glycol, 1,2-propanediol, 1,3-propanediol, diethylene glycol, dipropylene glycol, the isomeric butanediols, neopentyl glycol, 1,6-hexanediol, 2-ethylhexanediol and tripropylene glycol, as well as alkoxylated derivatives of these alcohols. Preferred dihydric alcohols are 1,6-hexanediol, dipropylene glycol and tripropylene glycol, Alcohols with more than two hydroxyl groups are glycerol, trimethylolpropane, ditrimethylolpropane, pentaerythritol and dipentaerythritol, as well as alkoxylated derivatives thereof.

Constituents of A5) which can be used concomitantly to accelerate the curing of the isocyanates with the respective isocyanate-reactive compounds A2) are the catalysts known in isocyanate chemistry. Suitable catalysts in the case of unblocked isocyanates are tertiary amines and tin, zinc or bismuth compounds, especially triethylamine, 1,4-diazabicyclo[2,2,2]octane, tin dioctoate or dibutyltin dilaurate.

The amount of catalyst A5) can be adapted to the curing requirements by those skilled in the art, consideration being given especially to the curing temperature, the required curing rate and optionally the pot life in the case of free isocyanate groups. Suitable amounts of catalyst to be used are e.g. 0.01 to 2 wt. %, preferably 0.05 to 1 wt. % and particularly preferably 0.07 to 0.6 wt. %, based on the total solids content.

Additives or auxiliary substances conventionally used in the technology of lacquers, paints, printing inks, sealants and adhesives can be present as component A6).

Other additives which can be used are stabilizers, light stabilizers such as UV absorbers and sterically hindered amines (HALS), especially N-acylated HALS like Sanduvor® 3058 (Clariant, Muttenz, CH) or Tinuvin® 622 (Ciba Speciality Chemicals Holding Inc., Basle, CH), and also antioxidants, fillers and lacquer aids, e.g. antisettling agents, defoaming agents and/or wetting agents, flow control agents, reactive thinners, plasticizers, catalysts, auxiliary solvents and/or thickeners, as well as pigments, dyestuffs and/or flatting agents. The use of light stabilizers and the various types are described for example in A. Valet, Lichtschutzmittel füir Lacke, Vincentz Verlag, Hannover, 1996. The proportions of amorphous polyurethanes A2), A3) and A4) can vary within wide limits. A high proportion of amorphous polyurethane in the coating composition improves the physical drying. Curing in non-exposed regions can also be influenced by the additional crosslinking mechanism. If component A3) contains many, optionally reactive isocyanate groups and if the proportions of isocyanate-reactive groups in A2) and/or the amorphous polyurethane are commensurate therewith—a ratio of isocyanate to isocyanate-reactive groups of 1:1 is preferred—the crosslinking density and hence the resistance in the non-irradiated region increase. As the proportion of A4 in the coating composition increases, so the physical drying deteriorates.. In non-irradiated regions, A4) remains uncrosslinked as a plasticizer. The amount of A4) is therefore preferably limited to less than 50 wt. %, especially less than 25 wt. %. The proportion of amorphous polyurethane in the coating composition is preferably more than 20 wt. %, especially more than 35 wt. %.

The coating compositions according to the invention can be prepared by first mixing together all the components that are free of isocyanate groups, the components that contain free isocyanate groups only being mixed in just before application to a substrate.

The coating compositions according to the invention can be applied to a very wide variety of substrates by the conventional techniques, for example by spraying, rolling, knife coating, pouring, spraying, brushing, impregnation or dipping, or by printing techniques such as gravure, flexographic or offset printing, or by transfer methods. Examples of suitable substrates are wood, metal, including particularly metal as used in so-cal led wire, coil, can or container lacquering applications, also plastic, including plastic in sheet form, especially ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM and UP (abbreviations as defined in DIN 7728T1), paper, leather, textiles, felt, glass, derived timber products, cork, inorganically bonded substrates such as plywood and fibreboard, electronic components or mineral substrates. It is also possible to lacquer substrates made up of different materials taken from those mentioned above, or already coated substrates. As a further possibility, the coating compositions can be applied only temporarily to a substrate, and then partially or completely cured and peeled off, e.g. to produce sheets.

The coating compositions according to the invention are preferably used in the repair lacquering of, in particular, vehicles such as motor vehicles, aeroplanes, ships and railway vehicles. Conventionally, said vehicles are provided with several layers of lacquer, each layer being composed of different coating compositions. If this lacquer is damaged, it is conventional to carry out repair lacquering, likewise in several layers. The coating compositions according to the invention can be used in appropriate formulations in each layer, especially in so-called primers or fillers and/or clear lacquers. Repair lacquering is preferably carried out using mobile and especially portable UV radiators. Preferred radiators are those which emit scarcely any UV-C radiation, or none at all, and only low proportions of UV-B radiation. Such radiators are obtainable for example from Dr. K. Hönle GmbH, DE, under the name UVAHAND, from Panacol-Elosol GmbH, DE, under the name Panacol H or Panacol F, and from H+S Autoshot, 10° Canada.

The applied layer thicknesses (prior to curing) are typically between 0.5 and 5000 μm, preferably between 5 and 1500 μm and particularly preferably between 15 and 1000 μm. If solvent is used, this is removed by the common methods after application.

Radiation curing is preferably effected by the action of high-energy radiation, i.e. UV radiation or daylight, e.g. light with a wavelength of 200 to 750 nm, or by irradiation with high-energy electrons (electron radiation, 90 to 300 keV). The radiation sources used for light or UV light are e.g. high-pressure mercury vapour lamps, it being possible for the mercury vapour to be modified by doping with other elements such as gallium or iron. Other possible radiation sources are lasers, pulsed lamps (known as UV flashlight radiators), halogen lamps or eximer radiators. The radiators can be fixed installations, in which case the object to be irradiated is moved past the radiation source by means of a mechanical device, or the radiators can be mobile, in which case the object to be irradiated does not move during curing. For UV curing the radiation dose that is conventionally sufficient for crosslinking ranges from 80 to 5000 mJ/cm².

Irradiation can optionally also be carried out with the exclusion of oxygen, e.g. under an inert gas atmosphere or an oxygen-reduced atmosphere. Suitable inert gases are preferably nitrogen, carbon dioxide, noble gases or combustion gases. Irradiation can also be carried out while the coating is covered with media transparent to the radiation, for example plastic sheets, glass or liquids such as water.

The type and concentration of any initiator used shall be varied in a manner familiar to those skilled in the art according to the radiation dose and curing conditions.

Particularly preferably, curing is effected using the UV-A radiators described above. Photoinitiators are then used in concentrations of 0.1 to 15 and particularly preferably of 2.0 to 7.0 wt. %, based on the solids content of the coating. These coatings are preferably cured using a dose of 200 to 3000 MJ/cm², measured in the wavelength range from 200 to 600 nm.

If the coating composition according to the invention contains isocyanate groups (component A3), it also cures under the action of thermal energy. The thermal energy can be introduced into the coating by radiation, thermal conduction and/or convection, it being conventional to use the infrared radiators, near infrared radiators and/or furnaces commonly employed in coating technology. In the case of repair lacquering, infrared radiators are preferred. Alternatively, the use of a heat source is dispensed with for curing because the ambient heat may be sufficient for gradual curing, making it unnecessary to introduce additional thermal energy into the system. In addition, a reaction with atmospheric moisture can also effect a proportion of the curing.

When isocyanate groups are present, two independent chemical mechanisms are initiated by the action of actinic radiation and thermal energy/ambient heat, so the actinic radiation/thermal energy sequence, and hence the sequence in which the mechanisms proceed, can be combined in any desired manner. Preferably, any organic solvent and/or water present are first removed by the methods conventionally used in coating technology. In a preferred variant, this is followed by complete or partial curing initially under the action of actinic radiation. Thermal curing can then follow immediately or at a later stage, either in the spatially identical place or in a separate place.

### EXAMPLES

All percentages are to be understood as being by weight (wt. %), unless indicated otherwise.

Acid number: reported in mg KOH/g sample, titration with 0.1 mol/l NaOH solution against bromothymol blue (ethanolic solution), colour change from yellow through green to blue, based on DIN 3682

Hydroxyl number: reported in mg KOH/g sample, titration with 0.1 mol/l methanolic KOH solution after acetylation with acetic anhydride in the cold under catalysis with dimethylaminopyridine

Isocyanate content: reported in %, back titration with 0.1 mol/l hydrochloric acid after reaction with butylamine, based on DIN EN ISO 11909

Gel permeation chromatography (GPC): elution with THF, RI detection, integration after calibration with polystyrene standard

Viscosities: rotating viscometer, measurements at 23° C. and 40 s⁻¹ shear rate

Glass transition temperatures.were determined by DSC (differential scanning calorimetry) using a heating rate of 10 K/min.

Preparation of components for Comparative Examples:

### Example 1

### Glycidyl-Functional Polyacrylate

Part 1: 1200 g of butyl acetate were placed in a V4A steel (chromium-nickel steel 1.4571) pressure reactor vessel and heated to 155° C. (internal reactor pressure approx. 2.7 bar). A solution of 924.0 g of glycidyl methacrylate, 805.2 g of methyl methacrylate and 818.4 g of n-butyl acrylate was then metered in over 3 h. A solution of 92.4 g of ditert-butyl peroxide (Peroxan® DB, Pergan GmbH, Bocholt, DE) in 160 g of butyl acetate was metered in simultaneously over 3.5 h. Stirring was continued for one hour and the mixture was cooled to 40° C. and finally filtered on a T5500 depth filter (Seitz-Filter-Werke, Bad Kreuznach, DE).

Part 2: 175.9 g of the product previously obtained in part 1, 18.6 g of acrylic acid, 0.20 g of tin 2-ethylhexanoate (Desmorapid® SO, Bayer AG, Leverkusen, DE), 0.39 g of 2,6-ditert-butyl-4-methylphenol, 1.96 mg of 2,2,6,6-tetramethyl-piperidin-1-oxyl and 4.91 g of butyl acetate were placed in a three-necked flask equipped with a reflux condenser, a stirrer and a gas inlet tube, and the mixture was heated to 90° C. and reacted for 22 h while nitrogen was being introduced. This yielded a product with a viscosity of 670 mPas/23° C., a solids content of 66.1%, an OH number of 88.7 mg KOH/g and an acid number of 4.8 mg KOH/g.

### Example 2

### Acryloyl-Functional and Hydroxy-Functional Polyacrylate

Example 1 was repeated except that 1200 g of butyl acetate, 636.9 g of glycidyl methacrylate, 1401.1 g of methyl methacrylate, 254.7 g of isobornyl methacrylate and 254.7 g of n-butyl acrylate, and a solution of 92.6 g of ditert-butyl peroxide (Peroxan® DB, Pergan GmbH, Bocholt, DE) in 160 g of butyl acetate, were used in part 1. 928.1 g of the product of part 1, 67.4 g of acrylic acid, 1.84 g of tin 2-ethylhexanoate (Desmorapid® SO, Bayer AG, Leverkusen, DE), 0.60 g of 2,6-ditert-butyl-4-methylphenol, 0.12 g of 2,5-ditert-butylhydroquinone, 1.84 g of p-methoxyphenol and 4.91 g of butyl acetate were then used in part 2. This yielded a product with a viscosity of 20,300 mPas/23° C., a solids content of 65.2%, an OH number of 59 mg KOH/g and an acid number of 5.7 mg KOH/g. Preparation of polyurethanes for the coating composition according to the invention:

### Example 3

Precursor: 907.3 g of isophorone diisocyanate (Desmodur® I, Bayer AG, Leverkusen, DE), 0.34 g of dibutyltin dilaurate (Desmorapid® Z, Bayer AG, Leverkusen, DE) and 0.68 g of 2,6-ditert-butyl-4-methylphenol were placed in a three-necked flask equipped with a reflux condenser, a stirrer and a gas inlet tube, and the mixture was heated to 50° C. 441.1 g of 2-hydroxypropyl acrylate were then metered in gradually. A temperature of between 50 and 65° C. was maintained by the strongly exothermic reaction. When the NCO content had reached 14.8%, the product was cooled.

Urethane acrylate: 108.1 g of the precursor, 0.10 g of 2,6-ditert-butyl-4-methyl-phenol and 40.0 g of butyl acetate were placed in a three-necked flask equipped with a reflux condenser, a stirrer and a gas inlet tube, and the mixture was heated to 70° C. 11.5 g of ethanediol were then metered in gradually. A temperature of between 70 and 75° C. was maintained by the exothermic reaction. When the NCO content had reached 0.1%, the product was cooled. Solids content: 74.1%, viscosity: 33,500 mPas/23° C., APHA colour index: 35.

### Example 4

Precursor: 1089.0 g of isophorone diisocyanate (Desmodur® I, Bayer AG, Leverkusen, DE), 0.38 g of dibtityltin dilaurate (Desmorapid® Z, Bayer AG, Leverkusen, DE) and 0.75 g of 2,6-ditert-butyl4-methylphenol were placed in a three-necked flask equipped with a reflux condenser, a stirrer and a gas inlet tube, and the mixture was heated to 50° C. 409.1 g of 2-hydroxypropyl acrylate were then metered in gradually. A temperature of between 50 and 65° C. was maintained by the strongly exothermic reaction. When the NCO content had reached 17.8%, the product was cooled.

Urethane acrylate: 669.9 g of the precursor, 0.60 g of 2,6-ditert-butyl-4-methyl-phenol and 200.0 g of butyl acetate were placed in a three-necked flask equipped with a reflux condenser, a stirrer and a gas inlet tube, and the mixture was heated to 70° C. 127.8 g of butanediol were then metered in gradually. A temperature of between 70 and 75° C. was maintained by the exothermic reaction. When the NCO content had reached 0.1%, the product was cooled. Solids content: 73.5%, viscosity: 22,000 mPas/23° C., APHA colour index: 38.

### Example 5

669.9 g of the precursor of Example 3, 0.52 g of 2,6-ditert-butyl-4-methylphenol and 300.0 g of butyl acetate were placed in a three-necked flask equipped with a reflux condenser, a stirrer and a gas inlet tube, and the mixture was heated to 70° C. 97.5 g of glycerol were then metered in gradually. A temperature of between 70 and 75° C. was maintained by the exothermic reaction. When the NCO content had reached 0.1%, the product was cooled. Solids content: 72.2%, viscosity: 64,000 mPas/23° C., APHA colour index: 37, hydroxyl number: 62 mg KOH/g.

Preparation of coating compositions according to the invention and comparative coating compositions, and coatings obtained therefrom:

| | Comparative | | | | According to the invention | | | |
|---|---|---|---|---|---|---|---|---|
| Example | 6 | 7 | 8 | 9 | 10 | 11 | 12 | 13 |
| Product of | 50.0 | | 50.0 | | | | | |
| Ex. 1 | | | | | | | | |
| Product of | | 50.0 | | 50.0 | | | | |
| Ex. 2 | | | | | | | | |
| Product of | | | | | | | 100.0 | |
| Ex. 3 | | | | | | | | |
| Product of | | | | | | | | 100.0 |
| Ex. 4 | | | | | | | | |
| Product of | | | | | 50.0 | 50.0 | | |
| Ex. 5 | | | | | | | | |
| PETIA | | | | | | | 18.5 | 18.5 |
| Photoinitiator | 4.8 | 4.3 | 7.6 | 6.1 | 4.7 | 6.6 | 10.5 | 10.5 |
| DBTL | 2.4 | 2.2 | 3.8 | 3.1 | 2.3 | 3.3 | 5.3 | 5.3 |
| Ethyl acetate | 10.0 | 25.0 | 19.9 | 34.9 | 20.0 | 27.6 | 50.0 | 48.0 |
| N3390 | 15.9 | 11.4 | | | 12.1 | | | |
| XP 2510 | | | 46.2 | 33.2 | | 35.1 | | |
| LS 2337 | | | | | | | 12.7 | 12.7 |
| All amounts are in [g]. | | | | | | | | |
| PETIA is the technical-grade reaction product of pentaerythritol with acrylic acid, containing hydroxyl groups, from UCB, S.A., BE. | | | | | | | | |
| A mixture of an alpha-hydroxy ketone (Irgacure ® 184, Ciba Speciality Chemicals, Basle, CH) with a monoacylphosphine oxide (Lucerin ® TPO, BASF AG, Ludwigshafen, DE) in a weight ratio of 3:1, as a 50% solution in ethyl acetate, was | | | | | | | | |
| # used as the photoinitiator. | | | | | | | | |
| DBTL represents a 1% solution of dibutyltin dilaurate (KEVER-KAT DBTL 162, Kever-Technologie GmbH & Co. KG, Ratingen, DE) in ethyl acetate. | | | | | | | | |
| N3390 represents Desmodur ® N3390 (Bayer AG, Leverkusen, DE), an aliphatic polyisocyanate based on hexamethylene diisocyanate, predominantly containing isocyanurate structural units, 90% solution in butyl acetate, NCO content: | | | | | | | | |
| # 19.6%, viscosity: 650 mPas/23° C. | | | | | | | | |

XP 2510 represents Roskydal ® UA XP 2510 (Bayer AG, Leverkusen, DE), an isocyanate-containing urethane acrylate, 90% solution in butyl acetate, NCO content: 6.7%, viscosity: 16,000 mPas/23° C.
LS 2337 represents Roskydal ® UA VP LS 2337 (Bayer AG, Leverkusen, DE), an isocyanate-containing urethane acrylate, 100%, NCO content: 12.5%, viscosity: 10,000 mPas/23° C.

To prepare the coating compositions, all the components not containing isocyanate were first mixed together homogeneously. The isocyanate-containing constituents were then stirred in immediately before application. The ready-formulated lacquers were then applied to glass plates with a 150 μm coating knife.

| | Comparative | | | | According to the invention | | | |
|---|---|---|---|---|---|---|---|---|
| Example | 6 | 7 | 8 | 9 | 10 | 11 | 12 | 13 |

Coating composition

| | | | | | | | | |
|---|---|---|---|---|---|---|---|---|
| Calculated solids content [%] | 60.4 | 48.4 | 60.4 | 50.4 | 55.2 | 56.7 | 56.1 | 56.6 |
| Flow time in DIN 4 | 20 | 20 | 20 | 20 | 20 | 20 | 20 | 20 |
| cup [s] | | | | | | | | |

Coating after surface drying without UV irradiation

| | | | | | | | | |
|---|---|---|---|---|---|---|---|---|
| T1 drying | 50 | 25 | 140 | 60 | 30 | 25 | 85 | 120 |
| (DIN 53150) [min] | | | | | | | | |
| T3 drying | 300 | 330 | >480 | >480 | 210 | >480 | >480 | >480 |
| (DIN 53150) [min] | | | | | | | | |

Coating after 15 min of surface drying and UV irradiation

| | | | | | | | | |
|---|---|---|---|---|---|---|---|---|
| UV curing for 2 min | tacky | soft | tacky | tacky | soft | hard | hard | hard |
| UV curing for 5 min | soft | hard | soft | hard | hard | hard | hard | hard |
| Layer thickness after | 35 | 35 | 40 | 35 | 35 | 35 | 45 | 45 |
| curing [μm] | | | | | | | | |
| Pendulum hardness | 53 | 76 | 53 | 80 | 122 | 165 | 157 | 165 |
| after 2 h at RT [s] | | | | | | | | |
| Pendulum hardness | 153 | 167 | 135 | 148 | 190 | 197 | 181 | 187 |
| after 96 h at RT [s] | | | | | | | | |

After 15 min of ventilation at RT, UV curing is effected with a Panacol UV-F 900 UV-A lamp from Panacol-Elosol GmbH, DE, by irradiation for 2 min or 5 min at a distance of 20 cm.

The layer thickness on the sample irradiated for 5 min was then measured with a DeFelsko 6000 meter from DeFelsko Corporation, New York, USA.

Only the binders according to the invention satisfy all the requirements: high solids content (over 55% for the spraying viscosity of a clear lacquer), good physical surface drying, e.g. in concealed regions (T1 drying in 120 min), high UV reactivity under pure UV-A light (UV curing in 2 to 5 min) and rapid post-curing (the pendulum hardness is over 120 s at most 2 h after irradiation). The comparative binders always fail to meet these requirements in at least two of the properties tested.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. Coating compositions which are curable by UV-A radiation and contain at least one amorphous polyurethane with a glass transition temperature of from 35° C. to 100° C., the proportion by weight of soft groups in said amorphous polyurethane being less than 30 wt. %.

2. Coating compositions according to claim 1, comprising the following as other components:
A1) at least one photoinitiator,
A2) optionally at least one compound which has at least one isocyanate-reactive group and optionally contains one or more functional groups that undergo a polymerization reaction with ethylenically unsaturated compounds under the action of actinic radiation,
A3) optionally polyisocyanates which optionally contain one or more functional groups that undergo a polymerization reaction with ethylenically unsaturated compounds under the action of actinic radiation,
A4) optionally compounds which carry functional groups that undergo a polymerization reaction with ethylenically unsaturated compounds under the action of actinic radiation, and which have neither isocyanate groups nor isocyanate-reactive groups,
A5) optionally catalysts and
A6) optionally auxiliary substances and additives, at least one of components A2) to A4) and/or the amorphous polyurethane containing one or more functional groups that undergo a polymerization reaction with ethylenically unsaturated compounds under the action of actinic radiation.

3. Coating compositions according to claim 1, wherein the amorphous polyurethanes have a glass transition temperature of 40 to 76° C.

4. Coating compositions according to claim 1, wherein the amorphous polyurethanes have a glass transition temperature of 40 to 52° C.

5. Coating compositions according to claim 1, wherein the amorphous polyurethanes have a linear molecular structure.

6. Coating compositions according to claim 1, wherein in addition to photochemical crosslinking, the compositions are curable by an additional crosslinking mechanism which proceeds at temperatures below 60° C. within eight hours to a sufficient degree of completion that even the non-irradiated coating cures until dry to handle.

7. Coating compositions according to claim 6, wherein the additional crosslinking mechanism is based on the isocyanate-hydroxyl reaction or the reaction of isocyanate with aminic components, or on both types of reaction simultaneously.

8. A process for the preparation of coating compositions according to claim 1, comprising mixing all of the components that are free of isocyanate groups, and mixing in the components that contain free isocyanate groups just before application to a substrate.

9. A method of repairing lacquering comprising applying the composition according to claim 1 to a lacquered object.

10. Large objects lacquered with the composition of claim 1.

11. The large objects according to claim 10, wherein the large objects are selected from motor vehicles, aeroplanes, ships and railway vehicles.

12. Substrates coated with at least one layer obtained from the coating compositions according to claim 1.

13. Coating compositions according to claim 1, wherein the auxiliary substances and additives A6) are selected from the group consisting of light stabilizers, antioxidants, fillers, antisettling agents, defoaming agents, wetting agents, flow control agents, reactive thinners, plasticizers, catalysts, solvents, thickeners, pigments, dyestuffs, flatting agents and combinations thereof.

14. Coating compositions according to claim 2, wherein the amorphous polyurethanes have a glass transition temperature of 40 to 76° C.

15. Coating compositions according to claim 2, wherein the amorphous polyurethanes have a glass transition temperature of 40 to 52° C.

16. Coating compositions according to claim 2, wherein the amorphous polyurethanes have a linear molecular structure.

17. Coating compositions according to claim 2, wherein in addition to photochemical crosslinking, the compositions are curable by an additional crosslinking mechanism which proceeds at temperatures below 60° C. within eight hours to a sufficient degree of completion that even the non-irradiated coating cures until dry to handle.

18. Large objects lacquered with the composition of claim 2.

19. The large objects according to claim 18, wherein the large objects are selected from motor vehicles, aeroplanes, ships and railway vehicles.

20. Substrates coated with at least one layer obtained from the coating compositions according to claim 2.
